(19) United States
(12) Patent Application Publication
(10) Pub. No.: US 2004/0088846 A1
(43) Pub. Date: May 13, 2004

(54) Method for in home servicing of dry cleaning machines

(75) Inventors: Dennis Stephen Murphy, Wyckoff, NJ (US); Michael Orchowski, East Rutherford, NJ (US); Robert Joseph Ahart, Mahwah, NJ (US)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/293,807

(22) Filed: Nov. 13, 2002

(51) Int. Cl. B23P 6/00; B23Q 17/00

(52) U.S. Cl. 29/402.02; 29/402.08; 29/407.01

(57) ABSTRACT

The invention provides a method of servicing a dry cleaning system in the home wherein the method comprises being notified or put on notice of the fact that an item or items needs servicing and providing a means (e.g., home delivery serviceperson) to inspect and, if necessary provide said servicing. The servicing may involve replacing, fixing and recycling an item or items (e.g., solvent) in need of servicing.

### FIELD OF THE INVENTION

The present invention is directed to a method of servicing various necessary maintenance items or problems which may arise in connection with the maintenance of dry cleaning machines (e.g., mechanical parts and/or chemical components), particularly dry cleaning machines using a continuous phase, non-aqueous fluid solvent. More particularly, the invention is directed to a method of being notified or on notice (e.g., notified by electronic or internet signal, by telephone or in person; or on notice through regular service contracting) that the maintenance item or problem (e.g., replacement or topping off of solvent; replacement of seals; replacement, cleaning and/or inspection of filters; inspection of possible leaks; inspection and/or cleaning of lines etc.) has arisen; providing means (preferably through a service agent) to inspect and/or address the required item (e.g., collect or remove spent solvent); optionally replace and/or fix needed item (e.g., replacing a fluid solvent as required); and optionally recycling and/or disposing of parts/components in a suitable manner.

### BACKGROUND OF THE INVENTION

It is desirable to have a dry cleaning apparatus to clean all types of laundry articles. The use of no water, or substantially no water, not only eliminates problems associated with conventional aqueous washing (e.g., shrinking, wrinkling), but also significantly reduces wash time because the water does not need to be dried off.

While the use of dry cleaning systems and of the continuous phase non-aqueous solvents associated with these systems addresses these issues, the machines and systems do require maintenance and have required components which need to be monitored, serviced and/or replaced (e.g., liquid solvent). For example, the solvents used in the machines do degrade and become dirty over time. As such, the solvent needs to be replaced or reprocessed periodically to yield optimum performance. Also, liquids need to be topped off, seals and filters need to be inspected, fixed and/or replaced etc.

The use of non-aqueous solvent is known in the art. U.S. Pat. No. 5,676,705 to Jureller et al., for example, discloses a dry cleaning method which employees densified carbon dioxide. U.S. Pat. No. 6,258,130 to Murphy discloses a dry cleaning system by using linear silicone oligomer and optionally functionalized surfactants and polar molecules.

None of the references discusses a method of servicing in home dry cleaning machines by being notified or on notice of a maintenance item or that a problem may have arisen in connection with the maintenance of the system (e.g., filters, solvent replacement etc.)

WO 01/94675 (assigned to P&G) discloses an apparatus for washing fabrics using non-aqueous fluid. The reference mentions elements of the apparatus and includes the idea that kits may be sold comprising, among other ingredients, non-aqueous fluid, to upkeep the machine. Again, however, there is no disclosure of a method of servicing by being notified (electronically or physically) or on notice of a maintenance item or that a problem may have arisen in connection with the maintenance of the dry cleaning system (e.g., machine or chemical component).

### SUMMARY OF THE INVENTION

The present invention provides a method of servicing dry cleaning machines comprising:

(1) being notified or being on notice (e.g., through a service contract which provides periodic checking) of any of a variety of necessary maintenance items or problems which may arise in connection with the maintenance of the machines (e.g., mechanical parts or chemical components);

(2) providing a means (e.g., preferably through use of a service agent sent to the home or business, for example, to collect spent fluid) to inspect the machine system part or chemical component of the system in order to address a situation and or problem;

(3) optionally replacing, fixing, and/or recycling a needed item; and

(4) optionally disposing of parts/components in a suitable manner as needed.

In a more specific embodiment of the invention (relating to replacing spent solvent, if required), the invention provides a method of servicing spent solvent in a dry cleaning system comprising:

(1) being notified or being on notice that solvent requires replacement;

(2) providing a means to collect and remove the spent solvent;

(3) replacing said spent solvent with new or reprocessed solvent; and

(4) recycling and/or disposing said solvent in a suitable manner.

### DETAILED DESCRIPTION OF THE INVENTION

The present invention relates to a method of servicing various necessary service items (mechanical and/or chemical and/or electrical, if needed) or problems which may arise in connection with maintenance of dry cleaning machines, particularly dry cleaning machines using non-aqueous fluid solvents.

More specifically, the dry cleaning process requires, for example, the use of a continuous phase, non-aqueous solvent to be applied to the laundry article during the cleaning process. (It should be clear that, although we are using the term “dry cleaning”, cleaning applies to all articles of laundry (e.g., clothes), including those traditionally cleaned in water and wherein, according to the subject invention, are cleaned in non-aqueous solvent).

While the non-aqueous solvent fluid is capable of being used over multiple cleaning cycles (e.g., from about 5 months to 5 years or typically 25 to 5000 wash cycles), eventually the solvent becomes “spent” so that either new solvent is required or the solvent must be reprocessed. By “spent” is meant that there is a chemical breakdown or rearrangement of the solvent itself and/or build-up of hard to remove impurities. Typically, the recycling of “spent” solvent means physical removal of the breakdown and rearrangement products and/or impurities by, for example, distillation.

Other mechanical and/or chemical and/or electrical servicing needs that may arise in connection with use of fluid solvents in home dry cleaning systems include, but are not limited to such items as:

(1) the need to replace (as noted) or to top-off (i.e., fill to a required, designated level) solvent when levels become low (e.g., more than 20% of initial solvent volume is lost);

(2) inspection and replacement or fixing of seals which may be worn or broken in the normal operation of the system;

(3) inspection and replacing or fixing of filters used in the dry cleaning system;

(4) inspection and fixing of leaks;

(5) inspection and replacing or fixing of lines used in the system;

(6) inspection and replacing or topping-off any other fluid or chemical component which is used in the system.

According to the subject invention, a method is provided whereby notification is provided (through electronic signal or simple telephone call, for example) that a servicing of some kind (e.g., inspect for spent solvent) is needed; means is provided to inspect; and optional replacing, fixing, recycling and/or disposal of item (mechanical, chemical or electric) is provided as required. In this way, what could otherwise be a difficult and/or burdensome job can be greatly facilitated, providing a much greater incentive to use these machines. In addition, there is the safety and expertise (e.g., experience) provided by a trained individual servicing rather than an untrained machine owner who probably has little or no experience.

Specifically the invention comprises a method of servicing the dry cleaning machine comprising:

(1) being notified or put on notice of the fact that an item or items needs to be inspected for possible further servicing;

(2) providing a means (e.g., an agent) to inspect for said possible servicing;

(3) optionally replacing, fixing and/or cleaning, depending on the servicing need; and

(4) optionally disposing of or recycling said part or component (chemical mechanical or electrical) in a suitable manner.

In a more specific embodiment of the invention (relating to replacing spent solvent, as required), the invention provides a method of servicing spent solvent in dry cleaning system comprising:

(1) being notified or being on notice that solvent requires replacement;

(2) providing a means to collect and remove the spent solvent;

(3) replacing said spent solvent with new or reprocessed solvent; and

(4) recycling and/or disposing said solvent in a suitable manner.

The laundry article(s) (e.g. soiled laundry article) which may be cleaned in the invention includes men's and women's suits, coats, rugs, slacks, curtains, upholstery and shirts although these articles are not intended to be limited in any way. As noted above, the intention is to cover even articles traditionally cleaned in water.

There generally is no limitation with respect to the continuous phase solvent (i.e., fluid) which may be employed herein other than that the solvent is a densified gas (e.g., fluid which is a gas at standard temperature and pressure), a biodegradable hydrocarbon, a branched hydrocarbon, a silicon comprising solvent, or a hydrofluoroether and capable of being a continuous phase in a dry cleaning application. Illustrative examples of the types of solvents which may be employed in this invention include carbon dioxide, silicone oil, Exxon DF2000®, HFE7200® (ex 3M) and glycolethers.

Regarding the solvent which is a densified gas, such a solvent may be, within the dry cleaning composition or process, a gas, liquid or supercritical fluid depending upon how densified the solvent is (how much pressure is applied at a given temperature) in the domestic cleaning application the solvent is used in. Carbon dioxide tends to be the preferred solvent when the solvent selected is one which is a densified gas.

As to the silicon comprising solvent which may be used in this invention, such a solvent is typically a commercially available cyclic-siloxane based solvent made available from Green Earth Cleaning, LLC. Such a solvent is generally one which has a flash point over about 65° C., with octamethyl-cyclotetrasiloxane and decamethyl-cyclopentasiloxane being most preferred. A more detailed description of such conventional siloxane comprising solvents may be found in U.S. Pat. No. 5,942,007, the disclosure of which is incorporated herein by reference.

Especially preferred silicon comprising solvents are those having the formula:

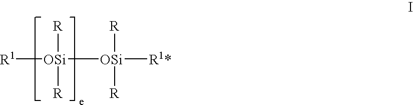

wherein each R is independently a substituted or unsubstituted linear, branched or cyclic C₁₋₁₀ alkyl, C₁₋₁₀ alkoxy, substituted or unsubstituted aryl, aryloxy, trihaloalkyl, cyanoalkyl or vinyl group, and R¹ is a hydrogen or a siloxyl group having the formula:

Si(R²)₃ II

and each R² is independently a linear, branched or cyclic C₁₋₁₀ substituted or unsubstituted alkyl, C₁₋₁₀ alkoxy, substituted or unsubstituted aryl, trihaloalkyl, cyanoalkyl, vinyl group, amino, amido, ureido or oximo group, and R^{1*} is an unsubstituted or substituted linear, branched or cyclic C₁₋₁₀ alkyl or hydroxy, or OSi(R²)₃ whereby R² is as previously defined, and e is an integer from about 0 to about 20.

The most preferred linear siloxane solvent is one wherein each R is methyl, R¹ is Si(R²)₃, R² is methyl and R^{1*} is methyl. Preferably, e is an integer from about 0 to about 10, and most preferably, an integer from about 2 to about 5.

Such solvents are made commercially available by General Electric, and Dow Corning under the name Dow Corning 200(R) fluid. A description of the solvents may be found in U.S. Pat. Nos. 3,931,047 and 5,410,007, the disclosures of which are incorporated herein by reference.

The biodegradable functionalized hydrocarbon that may be used in this invention can also be azeotropic solvent. Such an azeotropic solvent often comprises alkylene glycol alkyl ethers, like propylene glycol tertiary-butyl ether, and is described in U.S. Pat. No. 5,888,250, the disclosure of which is incorporated herein by reference. Moreover, as used herein, biodegradable functionalized hydrocarbon is defined to mean a biodegradable hydrocarbon comprising at least one member selected from the group consisting of an aldehyde, ketone, alcohol, alkoxy, ester, ether, amine, amide and sulfur comprising group.

When dry cleaning, for example, fabrics, like clothing or garments, with a solvent that is a densified gas, the machine which is employed for cleaning is well known in the art. Such a machine typically comprises a gas supply, cleaning tank and condenser. The machine may further comprise a means for agitation. The means for agitation may be, for example, a mechanical device like a mechanical tumbler, or a gas-jet agitator. The art recognized machines which may be used in this invention (e.g., when a densified gas is used) may be found in U.S. Pat. Nos. 6,012,307, 5,943,721, 5,925,192, 5,904,737, 5,412,958, 5,267,455 and 4,012,194, the disclosures of which are incorporated herein by reference. Other machines employable in the present invention are made commercially available by Alliance Laundry Systems.

When dry cleaning, for example, fabrics, like clothing or garments, with the biodegradable functionalized hydrocarbons or silicon comprising solvents and the surfactants described in this invention, the type of machine that may be used for the dry cleaning process is the same or substantially the same as the commonly used dry cleaning machines used for dry cleaning with perchloroethylene. Such machines typically comprise a solvent tank or feed, a cleaning tank, distillation tanks, a filter and solvent exit. These commonly used machines are described, for example, in U.S. Pat. No. 4,712,392, the disclosure of which is incorporated herein by reference.

When the fabric is placed in the machine and the continuous phase solvent of choice is fed into the machine, the normal cleaning cycle is run (typically between ten (10) minutes and one (1) hour). Prior to or after the start of the cleaning cycle, the surfactant (discussed below) may be introduced into the cleaning machine. Often, the amount of surfactant employed is from about 0.001 to about 15.0%, and preferably, from about 0.01 to about 5.0%, and most preferably, from about 0.01 to about 3.0% by weight of surfactant, based on total weight of surfactant and continuous phase solvent, including all ranges subsumed therein.

In addition to continuous phase solvent, it is especially preferred to add from about 0.01% to about 10.0%, and preferably, from about 0.03 to about 3.0%, and most preferably, from about 0.05 to about 0.3% by weight of a polar additive (e.g., C₁₋₁₀ alcohol and preferably water) based on total weight of continuous phase solvent, any surfactant used and polar additive, including all ranges subsumed therein. The addition of polar additive to the continuous phase solvent and optional surfactant is often desired so that cleaning may be enhanced, for example, by the formation of reverse micelles.

When cleaning fabrics, the pressure and temperature of the dry cleaning system (e.g., the system comprising the fabric targeted for cleaning, the continuous phase solvent and the surfactant described in this invention) within the machine is limited only to the extent that the temperature and pressure allow for the fabric to be cleaned. The pressure is often from about 1 to about 10,000 psi, and preferably, from about 200 to about 5,000 psi, and most preferably, from about 250 to about 3,000 psi, including all ranges subsumed therein. The temperature is often from about −30.0 to about 100° C., and preferably, from about −5.0 to about 70.0° C., and most preferably, from about 0.0 to about 45° C., including all ranges subsumed therein.

Adjunct Ingredients

Adjunct materials can vary widely and can be used at widely ranging levels. For example, detersive enzymes such as proteases, amylases, cellulases, lipases and the like as well as bleach catalysts including the macrocyclic types having manganese or similar transition metals all useful in laundry and cleaning products can be used herein at very low, or less commonly, higher levels. Adjunct materials that are catalytic, for example enzymes, can be used in “forward” or “reverse” modes, a discovery independently useful from the specific appliances of the present invention. For example, a lipolase or other hydrolase may be used, optionally in the presence of alcohols as adjuncts, to convert fatty acids to esters, thereby increasing their solubility in the non-aqueous fluid. This is a “reverse” operation, in contrast with the normal use of this hydrolase in water to convert a less water-soluble fatty ester to a more water-soluble material. In any event, any adjunct ingredient must be suitable for use in combination with the non-aqueous fluid.

The compositions may comprise emulsifiers. Emulsifiers are well known in the chemical art. Essentially, an emulsifier acts to bring two or more insoluble or semi-soluble phases together to create a stable or semi-stable emulsion. It is preferred in the claimed invention that the emulsifier serves a dual purpose wherein it is capable of acting not only as an emulsifier, but also as a treatment performance booster. For example, the emulsifier may also act as a surfactant thereby boosting cleaning performance. Both ordinary emulsifiers and emulsifier/surfactants are commercially available.

Some suitable cleaning additives include, but are not limited to, builders, surfactants, enzymes, bleach activators, bleach catalysts, bleach boosters, bleaches, alkalinity sources, antibacterial agents, colorants, perfumes, pro-perfumes, finishing aids, lime soap dispersants, composition malodor control agents, odor neutralizers, polymeric dye transfer inhibiting agents, crystal growth inhibitors, photo bleaches, heavy metal ion sequestrants, anti-tarnishing agents, anti-microbial agents, anti-oxidants, anti-redeposition agents, soil release polymers, electrolytes, pH modifiers, thickeners, abrasives, divalent or trivalent ions, metal ion salts, enzyme stabilizers, corrosion inhibitors, diamines or polyamines and/or their alkoxylates, suds stabilizing polymers, solvents, process aids, fabric softening agents, optical brighteners, hydrotropes, suds or foam suppressors, suds or foam boosters, fabric softeners, antistatic agents, dye fixatives, dye abrasion inhibitors, anti-crocking agents, wrinkle reduction agents, wrinkle resistance agents, soil release polymers, soil repellency agents, sunscreen agents, anti-fade agents, and mixtures thereof.

Examples of optional additives include an oxidizing agent, like hydrogen peroxide, and an organic bleach activator such as those represented by the formula:

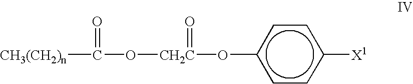

wherein n is an integer from about 0 to about 20 and X¹ is hydrogen or SO₃M and M is hydrogen, an alkaline metal or an immodium cation. A more detailed description of such additives may be found in U.S. Pat. No. 5,431,843, the disclosure of which is incorporated herein by reference.

Examples of anti-static agents include C₈-C₁₂ alcohol ethoxylates, C₈-C₁₂ alkaline glycols and glycol esters. The deodorizing agent, may include fragrances such as those described in U.S. Pat. No. 5,784,905, the disclosure of which is incorporated herein by reference.

Examples of hydrotropes include propylene glycol and sodium xylene sulphonate.

The term “surfactant” conventionally refers to materials that are surface-active either in the water, the non-aqueous fluid, or the mixture of the two. Some illustrative surfactants include nonionic, cationic and silicone surfactants as used in conventional aqueous detergent systems. Suitable nonionic surfactants include, but are not limited to:

(a) polyethylene oxide condensates of nonyl phenol and myristyl alcohol, such as in U.S. Pat. No. 4,685,930 Kasprzak; and

(b) fatty alcohol ethoxylates, R—(OCH₂CH₂)ₐOH a=1 to 100, typically 12-40, R=hydrocarbon residue 8 to 20 C atoms, typically linear alkyl. Examples include polyoxyethylene lauryl ether, with 4 or 23 oxyethylene groups; polyoxyethylene cetyl ether with 2, 10 or 20 oxyethylene groups; polyoxyethylene stearyl ether, with 2, 10, 20 21 or 100 oxyethylene groups; polyoxyethylene (2), (10) oleyl ether, with 2 or 10 oxyethylene groups. Commercially available examples include, but are not limited to: ALFONIC®, BRIJ®, GENAPOL®, NEODOL®, SURFONIC®, TRYCOL®. See also U.S. Pat. No. 6,013,683 Hill et al.

Suitable cationic surfactants include, but are not limited to dialkyldimethylammonium salts having the formula:

R′R″N⁺(CH₃)₂X⁻

where each R′R″ is independently selected from the group consisting of 12-30 carbon atoms or derived from tallow, coconut oil or soy, X═Cl or Br, Examples include: didodecyldimethylammonium bromide (DDAB), dihexadeceydimethyl ammonium chloride, dihexadecyldimethyl ammonium bromide, dioctadecyldimethyl ammonium chloride, dieicosyldimethyl ammonium chloride, didocosyldimethyl ammonium chloride, dicoconutdimethyl ammonium chloride, ditallowdimethyl ammonium bromide (DTAB). Commercially available examples include, but are not limited to: ADOGEBN, ARQUAD, TOMAH, VARIQUAT. See also U.S. Pat. No. 6,013,683 to Hill et al.

Suitable silicone surfactants include, but are not limited to the polyalkyleneoxide polysiloxanes having a dimethyl polysiloxane hydrophobic moiety and one or more hydrophilic polyalkylene side chains and have the general formula:

R¹—(CH₃)₂SiO—[(CH₃)₂SiO]ₐ[(CH₃)(R¹)SiO]_{b}—Si(CH₃)₂—R₁

wherein a+b are from about 1 to about 50, preferably from about 3 to about 30, more preferably from about 10 to about 25, and each R¹ is the same or different and is selected from the group consisting of methyl and a poly(ethyleneoxide/propyleneoxide) copolymer group having the general formula:

—(CH₂)ₙO(C₂H₄O)_{c}(C₃H₆O)_{d}R²

with at least one R¹ being a poly(ethyleneoxide/propyleneoxide) copolymer group, and wherein n is 3 or 4, preferably 3; total c (for all polyalkyleneoxy side groups) has a value of from 1 to about 100, preferably from about 6 to about 100; total is from 0 to about 14, preferably from 0 to about 3; and more preferably d is 0; total c+d has a value of from about 5 to about 150, preferably from about 9 to about 100 and each R² is the same or different and is selected from the group consisting of hydrogen, an alkyl having 1 to 4 carbon atoms, and an acetyl group, preferably hydrogen and methyl group. Examples of these surfactants may be found in U.S. Pat. No. 5,705,562 to Hill and U.S. Pat. No. 5,707,613 to Hill, both of which are incorporated herein by reference.

Examples of this type of surfactants are the Silwet® surfactants which are available from CK Witco, Osi Division, Danbury, Conn. Representative Silwet surfactants are as follows:

| Name | Average MW | Average a + b | Average total c |
|---|---|---|---|
| L-7608 | 600 | 1 | 9 |
| L-7607 | 1,000 | 2 | 17 |
| L-77 | 600 | 1 | 9 |
| L-7605 | 6,000 | 20 | 99 |
| L-7604 | 4,000 | 21 | 53 |
| L-7600 | 4,000 | 11 | 68 |
| L-7657 | 5,000 | 20 | 76 |
| L-7602 | 3,000 | 20 | 29 |

The molecular weight of the polyalkyleneoxy group (R¹) is less than or equal to about 10,000. Preferably, the molecular weight of the polyalkyleneoxy group is less than or equal to about 8,000, and most preferably ranges from about 300 to about 5,000. Thus, the values of c and d can be those numbers which provide molecular weights within these ranges. However, the number of ethyleneoxy units (—C₂H₄O) in the polyether chain (R¹) must be sufficient to render the polyalkyleneoxide polysiloxane water dispersible or water soluble. If propyleneoxy groups are present in the polyalkylenoxy chain, they can be distributed randomly in the chain or exist as blocks. Preferred Silwet surfactants are L-7600, L-7602, L-7604, L-7605, L-7657, and mixtures thereof. Besides surface activity, polyalkyleneoxide polysiloxane surfactants can also provide other benefits, such as antistatic benefits, and softness to fabrics.

The preparation of polyalkyleneoxide polysiloxanes is well known in the art. Polyalkyleneoxide polysiloxanes of the present invention can be prepared according to the procedure set forth in U.S. Pat. No. 3,299,112, incorporated herein by reference.

Another suitable silicone surfactant is SF-1488, which is available from GE silicone fluids.

These and other surfactants (e.g., including anionic and zwitterionic surfactants) suitable for use in combination with the non-aqueous fluid as adjuncts are well known in the art, being described in more detail in Kirk Other's Encyclopedia of Chemical Technology, 3^{rd} Ed., Vol. 22, pp.360-379, “Surfactants and Detersive Systems”, incorporated by reference herein. Further suitable nonionic detergent surfactants are generally disclosed in U.S. Pat. No. 3,929,678 to Laughlin et al., issued Dec. 30, 1975, at column 13, line 14 through column 16, line 6, incorporated herein by reference.

As to the amount of optional additives used with the surfactants of the present invention, such an amount is limited only to the extent that the additive does not interfere with the cleaning process.

According to the subject invention, an item or items needs to be inspected periodically (i.e., someone is “on notice” even if not actively notified). The need for inspection may be based, for example, on a period of time (e.g., 4 months to 5 years before something is expected to be worn or to need replacing or just to be “inspected”); or perhaps on the number of cycles of use (e.g., every 20 to 5000 cycles, preferably 100 to 1000 cycles to trigger “inspection”).

Notification can be provided by the machine owner/user/leaser in a variety of ways. For example, an indicator that the solvent is spent or needs to be topped off may be automatically relayed to a distant site; or an indicator may be monitored by the owner who may then call and/or contact a website for servicing.

The servicer may alternatively be on notice because there is an existing service contract which provides that the service contact the owner/user/contractor periodically within a defined period (e.g., every six months).

As can be noted, there are a multiplicity of ways in which the servicer can be contacted or be “on notice” and none of the methods described above is intended to limit this in any way.

According to the method of the invention, once notification occurs (actively or from being on notice), the servicer will dispatch a servicing agent or inspector to the home of the user where the inspection and/or servicing will occur. In one embodiment of the invention, this involves analyzing solvent to determine if it needs to be replaced or re-processed and to see if recycling and/or disposing it is required.

The agent will subsequently, as required, fix and/or recycle necessary component or element (chemical, mechanical or electrical), as needed.

Finally, according to the method of the invention, the element will be returned and/or disposed of in a suitable manner. This may include, for example, returning a spent fluid to the manufacturer, to a waste disposal facility or to a recycling facility.

Except in the operating and comparative examples, or where otherwise explicitly indicated, all numbers in this description indicating amounts or ratios of materials or conditions or reaction, physical properties of materials and/or use are to be understood as modified by the word “about”.

Where used in the specification, the term “comprising” is intended to include the presence of stated features, integers, steps, components, but not to preclude the presence or addition of one or more features, integers, steps, components or groups thereof.

The following examples are intended to further illustrate the invention and are not intended to limit the invention in any way.

Unless indicated otherwise, all percentages are intended to be percentages by weight.

### EXAMPLES

An example of how the method of the invention is conducted is set forth below:

A consumer's machine, which is based on siloxane solvent, notifies the manufacturer that it is time for the solvent to be replaced via the internet. A service person arrives at the house the next business day and replaces all of the solvent in the machine with new solvent and takes the old away for reprocessing. While in the home, the service person also replaces the rubber seals on the door of the machine and cleans out buildup in the surfactant delivery system.

A further example is described below:

A consumer who has a machine based on a linear siloxane solvent calls for a regularly scheduled servicing. The service person deems that the solvent does not need replacement, but tops off the solvent and changes the filters.

1. A method of servicing an in-home dry cleaning machine system comprising:
(1) being notified or put on notice of the fact that an item or items needs inspection for further servicing;
(2) providing a means to inspect for said possible servicing;
(3) optionally replacing, fixing and or recycling item or items needing servicing; and
(4) optionally recycling and/or disposing of said item in a suitable manner.

2. A method according to claim 1, wherein said item in need of inspection is replacement or topping-off of any chemical component used in the system.

3. A method according to claim 1, wherein said item in need of inspection is replacement or fixing of seals used in connection with the dry cleaning machine system.

4. A method according to claim 1, wherein said item in need of inspection is replacement or fixing of filters.

5. A method according to claim 1, wherein said item in need of inspection is replacement or fixing of lines used in the dry cleaning system.

6. A method according to claim 2, wherein said component is a fluid.

7. A method according to claim 6, wherein said fluid is solvent.

8. A method of servicing an in-home dry cleaning machine system comprising:
(1) being notified or put on notice that solvent needs replacement;
(2) providing a means to collect and remove spent solvent if needed;
(3) replacing said spent solvent with new or reprocessed solvent; and
(4) recycling and/or disposing said solvent in a suitable manner.
